(19) United States
(12) Patent Application Publication
(10) Pub. No.: US 2009/0282952 A1
(43) Pub. Date: Nov. 19, 2009

(54) Cold forged stainless tool and method for making the same

(75) Inventor: Chen-Chih Yen, Chiayi (TW)

Correspondence Address: CHARLES E. BAXLEY, ESQUIRE, 90 JOHN STREET, SUITE 309, NEW YORK, NY, 10038, US

(73) Assignee: Potzu Forging Co., Ltd.

(21) Appl. No.: 12/152,506

(22) Filed: May 14, 2008

(51) Int. Cl. B25B 13/06; B21D 22/00; B23P 13/00

(52) U.S. Cl. 81/124.6; 72/352; 29/557; 81/121.1

(57) ABSTRACT

A method for cold forging a stainless steel tool includes a preparation step, a cold forging step, a trimming step and a hardening step. At the preparation step, there is provided a billet of stainless steel. At the cold forging step, the billet is cold forged into a forged billet in a plurality of rounds. A gap between a round and a previous round is shorter than the time required for the time needed for the forged billet to return to the temperature in the beginning of the previous round. At the trimming step, the forged billet is lathed and grounded. At the hardening step, thermal treatment is conducted on the lathed, grounded, forged billet. A stainless steel tool is formed after cooling.

### FIELD OF INVENTION

The present invention relates to a cold forged stainless tool and a method for making the same to reduce the time and the loss of material, thus reducing the cost.

### BACKGROUND OF INVENTION

Conventional tools such as sockets and bits of screwdrivers are made of cast iron or alloy via fabrication such as cutting, molding, hot forging and cold forging. Then, they are subjected to trimming, finishing and hardening. To avoid rust, they are subjected to an antirust step such as electroplating. However, this conventional process consumes a lot of material, involves a lot of steps, takes a long period of time, and requires a lot of equipment and laboring. Therefore, the cost is high. Moreover, the electroplating causes a serious environmental problem as well as adds to the cost. Therefore, it is getting popular to use stainless steel as the material of tools.

Stainless steel is not suitable for cutting because of its high work-hardening rate. That is, the strength against the deformation (or “flow stress”) gets higher as the deformation proceeds so that the deformation (or “forming process”) becomes more difficult. Work-hardening rates drop as the temperature increases. Therefore, to facilitate the forming process, forging must be conducted at a temperature higher than the re-crystallization point, and such forging is called “hot forging.”

Referring to FIGS. 1 and 2, a conventional process for forming a stainless tool includes a preparation step 11, a heating step 12, a hot forging step 13, a trimming step 14 and a thermal treatment step 15.

At the preparation step 11, a cylindrical billet 21 of stainless is provided. At the heating step 12, the billet 21 is heated to 800 to 1150 degrees Celsius in a heating device. The actual temperature depends on the properties of the material and the rates for the change of the cross-sectional area. The temperature will be retained for some time so that the billet 21 is evenly hot. At the hot forging step 13, the heated billet 21 is hot forged into a forged billet 22. At the trimming step 14, the forged billet 22 is lathed and grounded. Finally, the thermal treatment step 15 is taken to increase the hardness of the stainless tool.

Although the billet 21 is heated to lower the flow stress so that only one round of hot forging is conducted, there are problems with this conventional process. Firstly, it is difficult to precisely control the size of the forged billet 22. Secondly, there is oxidation on the surface of the forged billet 22. To solve these problems, the forged billet 22 is made with big tolerance, and then lathed and grounded, thus reaching a desired size and surface. This is considerable waste of material. Moreover, the trimming step 14 takes a long period of time. It takes a long period of time and consumes a lot of energy to heat the billet 21. Therefore, the cost is high.

In other words, the problems with the foregoing conventional process are attributed to the high temperature that renders it difficult to precisely control the size and results in the oxidation. These problems can be avoided in a cold forging process that can reduce the cost in time and material. However, in the cold forging process, there could easily be cracks or slits in the stainless steel because of poor ductility. Moreover, due to high flow stress leading to considerable work hardening, the life of a cold forging tool is short and the cost in equipment is high. Therefore, it is critical to choose a proper type of stainless steel and a proper process to overcome this problem.

Regarding the choice of the type of the stainless steel, is regulated in ISO 1711-1 that the hardness of a socket must reach HRC 39. To make a stainless socket, martensite steel or precipitation hardening steel is used.

The present inventor tried to use precipitation hardening steel SUS630 and found that the initial flow stress is very high, i.e., the deformability is very low so that the life of the cold forging tool is very low. Therefore, the present inventor turned to SUS410, which is more deformable, and found that the life of the cold forging tool is longer but still far from an economic scale. The strength against erosion of a resultant tool is not as high as expected.

The present inventor has tried his best to search for related prior-art and found three references. Processes for cold forming tools from metal can be found in U.S. Pat. Nos. 2,417,569, 4,061,013 and 4,322,247 for example. However, all of these patents have failed to provide a process for cold forming tools with excellent strength against erosion at low costs for not having to heat a billet.

Therefore, the present invention is intended to obviate or at least alleviate the problems encountered in prior art.

### SUMMARY OF INVENTION

It is an objective of the present invention to provide a process for cold forging a stainless steel tool without the need for heating a billet, thus reducing the cost and increasing the strength against erosion.

To achieve the foregoing objective, the cold forged stainless steel tool is made of stainless steel including less than 0.30% of carbon, less than 1.00% of manganese, less than 0.04% of phosphor, less than 0.03% of sulfide, less than 1.00% of silicon, 12.00% to 14.00% of chromium, 2.00% to 3.00% of copper, 1.00% to 3.00% of molybdenum and iron.

It is another objective of the present invention to provide a process for cold forging a stainless steel tool to reduce the time and increase the life of a cold forging tool, thus reducing the cost.

To achieve the foregoing objective, the method includes a preparation step, a cold forging step, a trimming step and a hardening step. At the preparation step, there is provided a billet of stainless steel. At the cold forging step, the billet is cold forged into a forged billet in a plurality of rounds. A gap between a round and a previous round is shorter than the time required for the time needed for the forged billet to return to the temperature in the beginning of the previous round. At the trimming step, the forged billet is lathed and grounded. At the hardening step, thermal treatment is conducted on the lathed, grounded, forged billet. A stainless steel tool is formed after cooling.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a flow chart of a conventional process for cold forging a stainless steel socket.

FIG. 2 shows the hot forging of a stainless steel socket from a stainless billet.

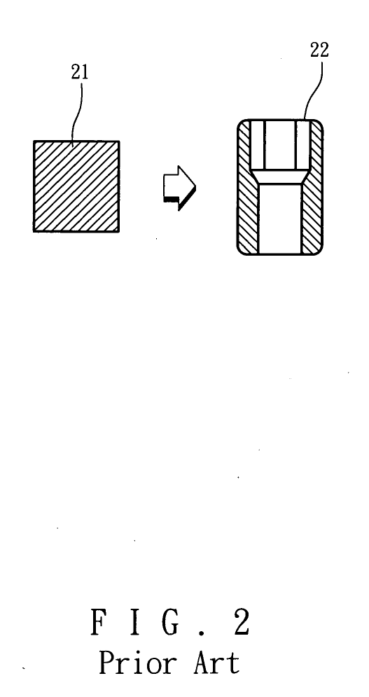

FIG. 3 is a flow chart of a process for cold forging stainless steel tool according to the preferred embodiment of the present invention.

FIG. 4 shows the cold forging of a stainless steel tool from a stainless steel billet in the process shown in FIG. 3.

FIG. 5 is a perspective view of the stainless steel tool shown in FIG. 4.

### DETAILED DESCRIPTION OF PREFERRED EMBODIMENT

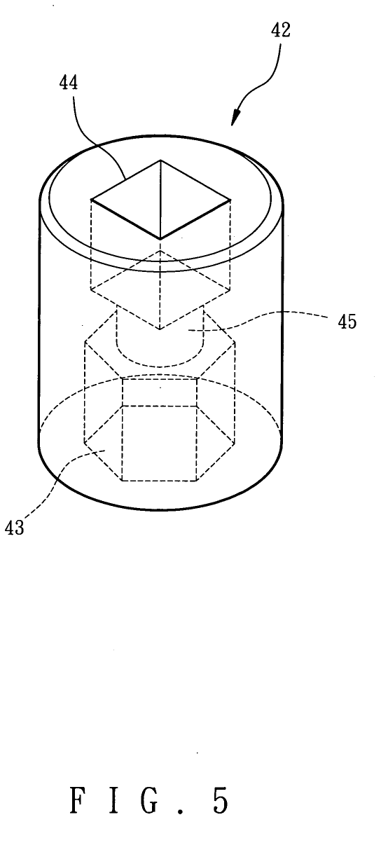

Referring to FIG. 5, there is shown a stainless steel tool and, more particularly, a stainless steel tool made in a cold forging process. The tool may be a socket or a bit of a screwdriver. The stainless steel used for the tool includes 0.30% of carbon or less, 1.00% of manganese or less, 0.04% of phosphor or less, 0.03% of sulfide or less, 1.00% of silicon or less, 12.00% to 14.00% of chromium, 2.00% to 3.00% of copper, 1.00% to 3.00% of molybdenum, iron and inevitable impurities. The stainless steel may additionally include 0.20% to 1.00% of nickel for enhancing the strength against rust.

The stainless steel preferably includes 0.10% to 0.25% of carbon, 0.40% to 0.80% of manganese, 0.01% to 0.03% of phosphor, 0.005% to 0.02% of sulfide, 0.40% to 0.80% of silicon or less, 12.50% to 13.40% of chromium, 2.10% to 2.70% of copper, 1.60% to 2.80% of molybdenum, iron and inevitable impurities.

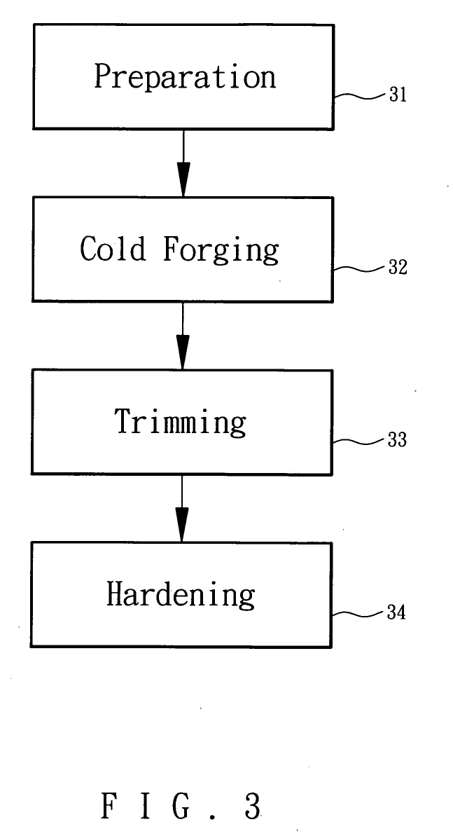

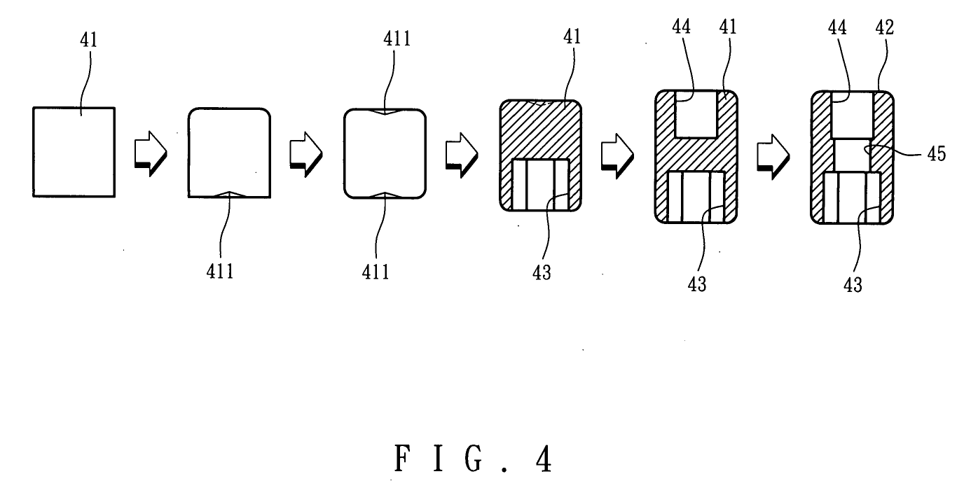

Referring to FIGS. 3 and 4, there is shown a process for cold forging a stainless steel tool according to the preferred embodiment of the present invention. The process includes a preparation step 31, a cold forging step 32, a trimming step 33 and a hardening step 34.

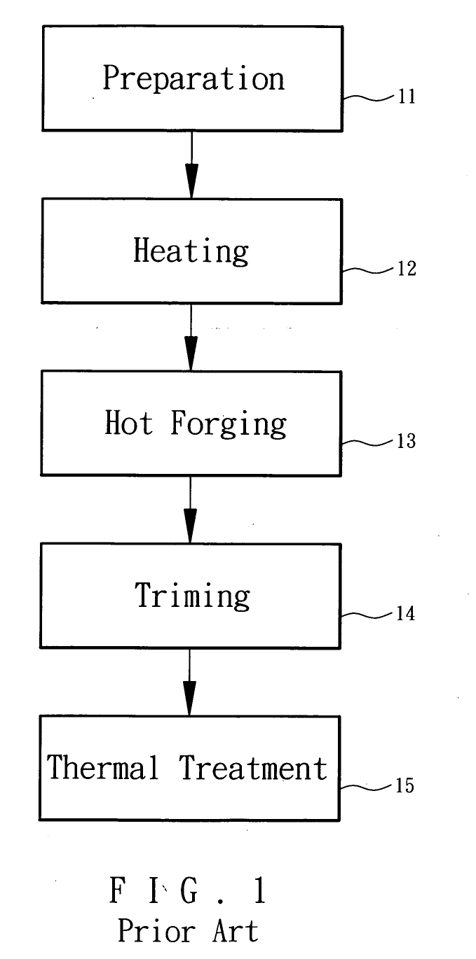

At the preparation step 31, there is provided a billet 41 of the stainless steel described with reference to FIG. 1. The billet 41 may be subjected to an annealing step to reduce the hardness thereof before the cold forging process. The annealing step is generally taken by a supplier of the billet 41.

At the cold forging step 32, the billet 41 is subjected to several rounds of cold forging, thus forming a forged billet 42. The gap between a round of cold forging and a previous round of cold forging is shorter than the time needed for the forged billet 42 to return to the temperature in the beginning of the previous round of cold forging. The gap is preferably shorter than 2 seconds. The gap is under control to make use of the increase of the temperature of the forged billet 42 because of the deformation in the previous round of cold forming so that the flow stress is reduced.

In the preferred embodiment, a multi-round horizontal forging machine is used to conduct 5 rounds of cold forging on the billet 41. The gap between a round of cold forging and a previous round of cold forging is shorter than 1 second. The change of molds (or “dies”) between two rounds of cold forging is done automatically. The first and second rounds of cold forging are used to preliminarily shape the billet 41 to delete right angles from two ends of the billet 41, i.e., chamfer the ends of the billet 41, thus reducing the concentration of stress. Moreover, a shallow cavity 411 is made in each of the ends of the billet 41 within each of the first and second rounds of cold forging. The third and fourth rounds of cold forging are used to make a deep hexangular cavity 43 within one of the ends of the billet 41 and a deep rectangular cavity 44 within the other end of the billet 41. The fifth round of cold forging is used to make an aperture 45 for communicating the deep hexangular cavity 43 with the deep rectangular cavity 44. Thus, the forged billet 42 is made.

The forming of the forged billet 42 is conducted in five rounds of cold forging. Deformation of the billet 41 is larger within the third and fourth rounds of cold forging than the first and second rounds of cold forging so that the increase of the temperature of the billet 41 is higher within the third and fourth rounds of cold forging than the first and second rounds of cold forging. Oil-based cooling can be used to cool the billet 41, thus keeping the temperature of the billet 41 under 250 degrees Celsius. The cold forging step 32 may include a different number of rounds of cold forging based on a different design of the forged billet 42. The billet 41 is a solid one in the preferred embodiment; it may however be a hollow one in another embodiment.

At the trimming step 33, the billet 42 is lathed and grounded. Because the forged billet 42 is made by cold forging, the size thereof is precise. The tolerance reserved for later processing is small. Hence, the amount of the material is small and the cost in material is low.

At the hardening step 34, the forged billet 42 is subjected to thermal treatment, thus increasing the hardness thereof. After cooling, the forged billet 42 is turned into the tool.

Since the gap between a round of cold forging and a previous round of cold forging is shorter than 2 seconds and preferably 1 second, the increase in the temperature caused in the previous round of cold is effectively used to keep the forged billet 42 warm, thus reducing work hardening that would otherwise affect the deformability of the forged billet 42 and extending the life of the cold forging tool. Therefore, the cold forging of the stainless steel tool is rendered practical. The billet 41 is not heated before it is forged. Therefore, the time and energy for heating are saved.

Moreover, because the forged billet 42 is made by cold forging, the size thereof is precise. The tolerance reserved for later processing is small. Hence, the amount of the material is small and the cost in material is low. Although including several rounds of cold forging, the cold forging step 32 takes less time than lathing and grounding would take in a conventional process because each round only takes several seconds. Therefore, the time for the process according to the present invention is short, and the cost in material is low, and there is no cost in heating the billet 41 at all.

Conclusively, within the process for cold forming the stainless steel tool according to the present invention, the gap between a round of cold forging and a previous round of cold forging is shorter than 2 seconds so that the increase in the temperature of the forged billet 42 is used to reduce the work hardening of the forged billet 42 to increase the deformability of the forged billet 42 and extend the life of the cold forging tool without having to heat the billet 41. Furthermore, because the forged billet 42 is made by cold forging, the size thereof is precise. The tolerance reserved for the later processing is small. The time for the later processing is short. As a whole, the process according to the present invention takes only a little time and results in a low cost.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A cold forged stainless steel tool made of stainless steel comprising less than 0.30% of carbon, less than 1.00% of manganese, less than 0.04% of phosphor, less than 0.03% of sulfide, less than 1.00% of silicon, 12.00% to 14.00% of chromium, 2.00% to 3.00% of copper, 1.00% to 3.00% of molybdenum and iron.

2. The cold forged stainless steel tool according to claim 1, wherein the tool is a socket.

3. The cold forged stainless steel tool according to claim 1, wherein the stainless steel comprises 0.10% to 0.25% of carbon, 0.40% to 0.80% of manganese, 0.01% to 0.03% of phosphor, 0.005% to 0.02% of sulfide, 0.40% to 0.80% of silicon or less, 12.50% to 13.40% of chromium, 2.10% to 2.70% of copper, 1.60% to 2.80% of molybdenum and iron.

4. A cold forged stainless steel tool according to claim 1, wherein the stainless steel comprises 0.20% to 1.00% of nickel for enhancing the strength against rust.

5. A cold forged stainless steel tool according to claim 3, wherein the stainless steel comprises 0.20% to 1.00% of nickel for enhancing the strength against rust.

6. A method for cold forging a stainless steel tool including the steps of:
providing a billet of stainless steel;
cold forging the billet into a forged billet in a plurality of rounds so that a gap between a round and a previous round is shorter than the time required for the time needed for the forged billet to return to the temperature in the beginning of the previous round;
lathing and grounding the forged billet; and
thermal treating the lathed, grounded, forged billet, thus forming a stainless steel tool after cooling.

7. The method according to claim 6, wherein the stainless steel comprising less than 0.30% of carbon, less than 1.00% of manganese, less than 0.04% of phosphor, less than 0.03% of sulfide, less than 1.00% of silicon, 12.00% to 14.00% of chromium, 2.00% to 3.00% of copper, 1.00% to 3.00% of molybdenum and iron.

8. The method according to claim 7, wherein the stainless steel comprises 0.10% to 0.25% of carbon, 0.40% to 0.80% of manganese, 0.01% to 0.03% of phosphor, 0.005% to 0.02% of sulfide, 0.40% to 0.80% of silicon or less, 12.50% to 13.40% of chromium, 2.10% to 2.70% of copper, 1.60% to 2.80% of molybdenum and iron.

9. The method according to claim 7, wherein the stainless steel comprises 0.20% to 1.00% of nickel for enhancing the strength against rust.

10. The method according to claim 8, wherein the stainless steel comprises 0.20% to 1.00% of nickel for enhancing the strength against rust.

11. The method according to claim 6, wherein the gap is shorter than 1 second.

12. The method according to claim 6, wherein the tool is a socket.

13. The method according to claim 6, wherein the billet is solid.

14. The method according to claim 6, wherein the billet is hollow.
